(19) United States
(12) Patent Application Publication
(10) Pub. No.: US 2010/0060237 A1
(43) Pub. Date: Mar. 11, 2010

(54) BATTERY DISCHARGE CIRCUIT AND DISCHARGE METHOD THEREOF

(75) Inventor: Hsing-Yuan HSIEH, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/509,041

(22) Filed: Jul. 24, 2009

(30) Foreign Application Priority Data
Sep. 5, 2008 (CN) 200810304395.9

(51) Int. Cl. H02J 7/00

(52) U.S. Cl. 320/136

(57) ABSTRACT

A battery discharge circuit, used to couple a battery to an electronic device, includes a battery protecting module and a voltage adjusting module. The battery protecting module detects an output voltage of the battery, compares the output voltage with an end voltage of the battery, and selectively discharges the battery or not in response to the comparison result. The voltage adjusting module compares the output voltage with a work voltage of the electronic device, and selectively directly outputs the output voltage or boosts the output voltage first and then outputs the boosted output voltage.

### BACKGROUND

1. Technical field

The present invention relates to battery discharge circuits and discharge methods thereof, and particularly to a battery discharge circuit and discharge method thereof that can completely release the power of a battery.

2. Description of the Related Art

Mobile communication has been playing an important role in the rapidly developed technological fields. Users place more reliance on mobile phones than ever, since mobile phone enables a user to keep contact with others at any place and at any time. A mobile phone obtains almost all of its operating power from a rechargeable battery.

In use, the battery outputs an output voltage to support the mobile phone working at an optimal working status. The output voltage should be higher than a work voltage of the mobile phone to activate the mobile phone. The output voltage of the battery drops as the battery works. When the output voltage falls below the work voltage, the mobile phone stops working and the battery stops discharging.

Overdischarge occurs when the battery continues to discharge even when the output voltage is below an end voltage. Overdischarge always causes irreversible damage to the battery and should be avoid.

Typically, the work voltage is higher than the end voltage, so that overdischarge can be avoid. However, since the work voltage is higher than the end voltage, the battery can not completely discharge and always retains some energy therein. Thus, the battery does not release power effectively enough.

Therefore, there is a room for improvement within the art.

### BRIEF DESCRIPTION OF THE DRAWINGS

Many aspects of the exemplary battery discharge circuit and discharge method thereof can be better understood with reference to the following drawings. These drawings are not necessarily drawn to scale, the emphasis instead being placed upon clearly illustrating the principles of the exemplary battery discharge circuit and discharge method thereof. Moreover, in the drawings like reference numerals designate corresponding parts throughout the several views. Wherever possible, the same reference numbers are used throughout the drawings to refer to the same or like elements of an embodiment.

FIG. 1 is a block diagram of a battery discharge circuit, according to an exemplary embodiment.

FIG. 2 is a flowchart of a discharge method of the battery discharge circuit.

### DETAILED DESCRIPTION OF THE PREFERRED EMBODIMENT

The present battery discharge circuit is suitably assembled within a portable electronic device, such as a lap computer, a mobile phone, a personal digital handset, or the like.

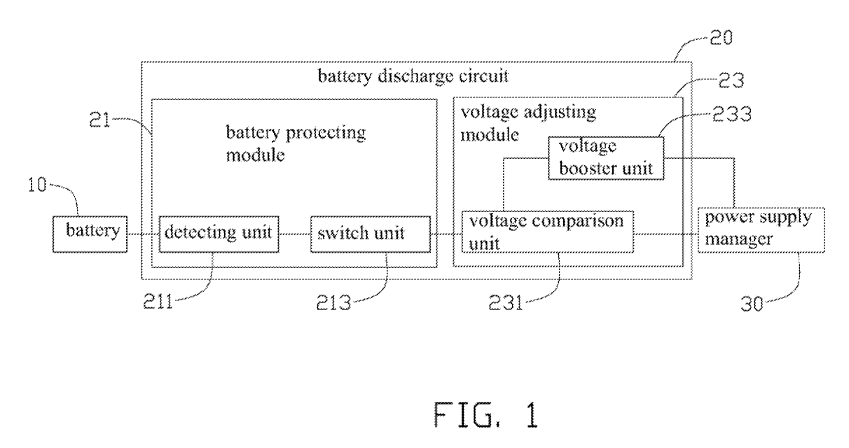

Referring to FIG. 1, an exemplary battery discharge circuit 20 is coupled between a battery 10 and a power supply manager 30 of a portable electronic device. The battery discharge circuit 20 includes a battery protecting module 21, and a voltage adjusting module 23.

The battery 10, can be a lithium ion (Li+) battery, is rechargeable, and configured to provide power to the power supply manager 30. The battery 10 defines an output voltage (Vₒᵤₜ), a work voltage (V_{work}) and an end voltage (V_{end}). Vₒᵤₜ initially is higher than V_{work} to activate the electronic device to work, and then drops as the battery 10 discharges. V_{work} is a lowest voltage enabling the electronic device to work. V_{end} is a threshold voltage after which overdischarge occurs when the battery 10 continues to discharge under the condition that Vₒᵤₜ is lower than V_{end}. For instance, V_{work} and V_{end} of a Li+ battery used in a mobile phone are about 3.6V and 2.5V, respectively.

The battery protecting module 21 is configured to monitor Vₒᵤₜ of the battery 10, and shut down the connection between the battery 10 and the power supply manager 30 to terminate discharge of the battery 10 when Vₒᵤₜ falls below V_{end} to protect the battery 10 from damage of overdischarge. The battery protecting module 21 includes a detecting unit 211 and a switch unit 213. The detecting unit 211 electronically connects with the battery 10, monitors Vₒᵤₜ of the battery 10, compares Vₒᵤₜ and V_{end}, and outputs a trigger signal to the switch unit 213 when Vₒᵤₜ drops to V_{end}. The switch unit 213 is used to control discharge of the battery 10, and connects with the detecting unit 211. When Vₒᵤₜ is higher than V_{end}, the switch unit 213 is on a turn-on mode, which means there is current flow passing therethrough. When the switch unit 213 receives the trigger signal which means Vₒᵤₜ drops to V_{end}, the switch unit 213 turns to a cut-off mode and there is no current flow passing therethrough thereby terminating discharge of the battery 10. Therefore, overdischarge of the battery 10 can be prevented by using the battery protecting module 21.

The voltage adjusting module 23 is used to boost Vₒᵤₜ to V_{work} when Vₒᵤₜ falls below V_{work}, and includes a voltage comparison unit 231 and a conventional voltage booster unit 233. The voltage comparison unit 231 serially connects between the switch unit 213 and the power supply manager 30, and the voltage booster unit 233 serially connects between the voltage comparison unit 231 and the power supply manager 30. The voltage comparison unit 231 receives Vₒᵤₜ from the switch unit 213, compares Vₒᵤₜ with V_{work}, and selectively transfers Vₒᵤₜ to the power supply manager 30 or to the voltage booster unit 233 in response to the comparison result. The voltage comparison unit 231 transfers Vₒᵤₜ directly to the power supply manager 30 when Vₒᵤₜ is higher than V_{work}, otherwise the voltage comparison unit 231 transfers Vₒᵤₜ to the voltage booster unit 233. The voltage booster unit 233 receives Vₒᵤₜ, boosts Vₒᵤₜ to V_{work} and then transfers the boosted Vₒᵤₜ to the power supply manager 30.

The power supply manager 30 receives voltage from the battery discharge module 20, and converts the received voltage to several varied voltages to corresponding components of the electronic device to enable the electronic device. The power supply manager 30 is activated to work when received the work voltage.

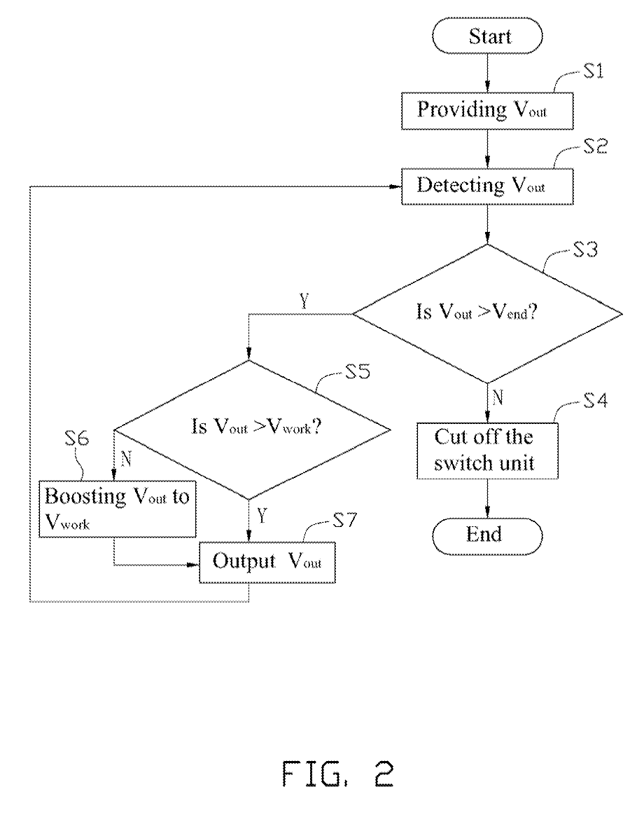

Referring to FIG. 2, a discharge method of the battery discharge circuit 20 may include the following steps.

S1: Providing a Vₒᵤₜ by discharge of a battery 10.

S2: Detecting Vₒᵤₜ by a voltage detecting unit 211 of a battery protecting module 21.

S3: Comparing Vₒᵤₜ with V_{end} and selectively turn on or cut off the switch unit 213 in response to the comparison result, wherein turn on the switch unit 213 and goes to step S5 if Vₒᵤₜ is higher than V_{end}, otherwise goes to step S4.

S4: Cut off the switch unit 213, thus terminating discharge of the battery 10.

S5: Comparing Vₒᵤₜ with V_{work}, wherein Vₒᵤₜ is compared with V_{work} by a voltage comparison unit 231 of a voltage adjusting module 23, and selectively output Vₒᵤₜ or transfer Vₒᵤₜ to a conventional voltage booster unit 233 of the voltage adjusting module 23 in response to the comparison result, wherein goes to step S7 to output Vₒᵤₜ if Vₒᵤₜ is higher than V_{work}, otherwise goes to step S6 to transfer Vₒᵤₜ to the voltage booster unit 233.

S6: Boosting Vₒᵤₜ to V_{work} by the voltage booster unit 233.

S7: Output Vₒᵤₜ and return to step 2.

In the exemplary embodiment of the present invention, overdischarge of the battery 10 can be avoid by using battery protecting module 20. In addition, the amount of energy of the battery 10 during Vₒᵤₜ drops from V_{work} to V_{end} can be effectively used by using the voltage booster unit 233.

It is to be understood, however, that even though numerous characteristics and advantages of the exemplary invention have been set forth in the foregoing description, together with details of the structure and function of the exemplary invention, the disclosure is illustrative only, and changes may be made in detail, especially in matters of shape, size, and arrangement of parts within the principles of exemplary invention to the full extent indicated by the broad general meaning of the terms in which the appended claims are expressed.

What is claimed is:

1. A battery discharge circuit, used to couple a battery to an electronic device comprising:
a battery protecting module for detecting an output voltage of the battery, comparing the output voltage with an end voltage of the battery, and selectively discharge the battery or not in response to the comparison result; and
a voltage adjusting module connecting to the battery protecting module, and comparing the output voltage with a work voltage of the electronic device, and selectively directly output the output voltage or boosting the output voltage first and then output the boosted output voltage.

2. The battery discharge circuit as claimed in claim 1, wherein the battery protecting module comprises a detecting unit configured to connect with the battery, detect the output voltage and compare the output voltage with the end voltage.

3. The battery discharge circuit as claimed in claim 2, wherein the battery protecting module further comprises a switch unit connecting with the detecting unit and configured to turn to a cut-off mode to terminate discharge of the battery when the output voltage is below the end voltage.

4. The battery discharge circuit as claimed in claim 1, wherein the voltage adjusting module comprises a voltage comparison unit serially connected between the battery protecting module and the electronic device to receive the output voltage, and configured to compare the output voltage with the work voltage and directly output the output voltage to the electronic device when the output voltage is higher than the work voltage.

5. The battery discharge circuit as claimed in claim 4, wherein the voltage adjusting module further comprises a voltage booster unit serially connected between the voltage comparison unit and the electronic device, and configured to receive the output voltage from the voltage comparison unit, boost the output voltage to the work voltage and output the boosted output voltage to the electronic device when the output voltage is below the work voltage.

6. A discharge method of the battery discharge circuit as claimed in claim 1, comprising:
detecting an output voltage of a battery;
comparing the output voltage with an end voltage of the battery;
selectively discharge the battery or not in response to the comparison result;
comparing the output voltage with a work voltage of an electronic device; and
selectively directly output the output voltage or boosting the output voltage first and then output the boosted output voltage.

7. The discharge method as claimed in claim 6, wherein the step c of selectively discharge the battery or not in response to the comparison result further comprises: discharging the battery when the output voltage is higher than the end voltage; and terminating the discharge of the battery when the output voltage is below the end voltage.

8. The discharge method as claimed in claim 6, wherein the step of selectively directly output the output voltage or boosting the output voltage first and then output the boosted output voltage further comprises: directly output the output voltage when the output voltage is higher than the work voltage; and boosting the output voltage first and then output the boosted output voltage when the output voltage is below the work voltage.
